(19) United States
(12) Patent Application Publication
(10) Pub. No.: US 2003/0188292 A1
(43) Pub. Date: Oct. 2, 2003

(54) System and method for configuration using an object tree formed of hierarchically graduatable objects

(76) Inventor: Gebhard Herkert, Limbach (DE)

Correspondence Address: STAAS & HALSEY LLP, SUITE 700, 1201 NEW YORK AVENUE, N.W., WASHINGTON, DC, 20005, US

(21) Appl. No.: 10/390,179

(22) Filed: Mar. 18, 2003

(30) Foreign Application Priority Data
Mar. 18, 2002 (DE) 10211953.8

(51) Int. Cl. G05B 11/01; G06F 9/44

(52) U.S. Cl. 717/105; 700/17

(57) ABSTRACT

An automation system is configured to obtain a standard configuration with simultaneously consistent data storage for a standard data model based on an object tree with hierarchically graduatable objects.

### CROSS REFERENCE TO RELATED APPLICATIONS

This application is based on and hereby claims priority to German Application No. 102 11 953.8 filed on Mar. 18, 2002, the contents of which are hereby incorporated by reference.

### BACKGROUND OF THE INVENTION

1. Field of Invention

The invention relates to a system and a method for configuring automation systems, in particular, and to a computer program product for carrying out such a method.

2. Description of Related Art

Such a system is used, in particular, in the field of automation technology. To produce, edit, analyze and display such an automation program, programming tools are used which are able to be executed on a data processing apparatus.

To configure automation plants, there are currently different special systems with independent data storage. Examples of such systems are as follows: signal lists for programmable logic controllers (PLC signal lists), PLC sequence programs, NC programs, recipe controllers, systems for operating and observing etc. For such special systems, different data stores and data structures are used. Similarly, processing mechanisms frequently need to be implemented and maintained on a multiple basis, which results in increased development involvement.

### SUMMARY OF THE INVENTION

An object of the invention is to provide a system and a method which allow standard configuration with simultaneous high data consistency.

The invention is based on the insight that a configuration system for software components, particularly a configuration system for software components in an automation system, generally has data available on a multiple basis and these data generally need to be entered on a multiple basis, which results not only in a much higher level of maintenance involvement but also in higher susceptibility to error and in problems regarding data consistency. By contrast, the software architecture of the novel system is based on a software component which has a data structure formed of an object tree with hierarchically graduatable objects. Such a data structure allows single data storage for all subsystems, such as sequence programs, logic controllers, 2D visualization, 3D visualization etc. All the software components have a standard data structure and database for all the plant components, since all the components form the basis of one and the same structural mechanism. Overall, a single object structure is obtained within a project, which means that changes also become possible using a single copying mechanism, using a single instantiation mechanism, using a single erasure mechanism etc. In this case, the basis of a single object structure relates both to classes and to instances of software components. The result of this is that, when classes are modified, all instances' data can immediately be updated, which achieves data consistency, or allows data consistency to be achieved, at any time.

Significantly reduced involvement for data maintenance is advantageously supported further by virtue of the object tree being provided for the purpose of mapping all the views of a software component. In this case, all the views of the software component are available in a single structure, namely in the object tree, which means that erasure and copying operations for such a software component require only a single erasure and copying mechanism.

Simple production of prototypes of a software component is achieved by virtue of the system having a first software component type as a class for a software component.

An immediate functional test on a software component can easily be ensured without additional involvement, for example through compilation, by virtue of the first software component type containing data or executable functions.

Simple production of machine language can be made possible by virtue of the system containing a generation algorithm which is provided for generating machine language from the object tree (e.g. S7 code).

Low-involvement reuse of software components already produced is achieved by virtue of the system having a second software component type as an instance of the software component. Such an instance of a class is a full duplicate of the corresponding class of software components including all of the data and functions.

Automatic changing of the data for instances associated with a class is ensured by virtue of the system having means for automatically changing an instance produced from a class if the corresponding class is changed. Similarly, changing an instance results both in the class changing and in all other instances changing.

Continuous data storage both for classes and for instances is obtained by virtue of the first and second software component types being of the same design.

A hierarchic instantiation system can be achieved by virtue of the system having means for generating more complex objects or software components from previously generated objects.

The system's multi-user capability can be ensured easily and safely by virtue of the system having means for producing a change list, being provided the change list for logging changes in a software component. This allows changes to be made and tested locally, for example, in a change copy of a software component first without the changes immediately resulting in changes in the original and in the associated instances.

Using the automatically generated change list, the changes can then be transferred to the original component and to all associated instances if required, which means that the change list generated for a first software component is provided for implementing the changes stored in the change list on a second software component, particularly on all other instances.

A simple and clear architecture for the individual objects is obtained by virtue of a software component's object having object nodes.

A low-involvement multilingual capability in the software components can be achieved by virtue of an object node having an identification number for defining different foreign language texts for an object.

Complex objects can be produced from individual simpler objects by virtue of the base nodes being able to be organized in a hierarchy for the purpose of generating more complex objects.

A continuous basic architecture for the objects and software components is achieved by virtue of the object having an elementary node function with a hierarchic breakdown.

In addition, a link mechanism is provided which allows logic combination of both signals and objects.

A particular object behavior can be defined safely and easily by virtue of the object being provided with a base node function for the purpose of determining the functionality of a node.

Logically combining more complex objects with other complex objects is made possible by virtue of the respective objects to be logically combined being able to be assigned at least one instance of a common interface class. Interconnecting the interface classes allows signal interchange.

The overall functionality of a software component, also for more complex objects, can be defined by virtue of a link mechanism being provided for logically combining signals or objects in order to generate a functionality for an object or a software component.

Compatibility with description languages customary in automation technology can be ensured by virtue of the object tree being provided for the purpose of mapping at least one of a function diagram, a flowchart and a sequencer for an automation component.

2D and 3D graphics can also easily be achieved by virtue of the object tree being provided for the purpose of mapping a 2D graphic or a 3D graphic.

More complex objects can be generated from previously generated less complex objects by virtue of the system containing a type/instance concept which is provided so that changes to a class result in all instances being concomitantly changed directly or by control.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1a is a block diagram of the basic design of an automation system with an OTR core as configuration system,

FIG. 1b is a block diagram of the basic design of an automation system with an OTR core as a configuration system and an OTR core as a runtime system in a programmable logic controller (PLC),

FIG. 2 is a block diagram of the basic design of an object tree and its interaction with different views,

FIG. 3 is a block diagram of the basic interplay between various object trees,

FIG. 4 is a block diagram of the general data structure of an object in an object tree,

FIG. 5 is a block diagram of the data structure of an object for producing multilingual software components,

FIG. 6 is a block diagram of an object tree with objects broken down,

FIG. 7 is a block diagram of a screen window for defining the functionalities of an object tree with hierarchically graduatable objects,

FIG. 8 is a block diagram providing an exemplary illustration of the production of function diagrams using an object tree,

FIG. 9 is a block diagram providing an exemplary illustration of the production of 3D graphics using an object tree,

FIG. 10 is a block diagram of an object tree with broken down objects using the type/instance concept,

FIG. 11 is a block diagram of a design for plant modules using a type/instance concept,

FIG. 12a is a block diagram providing an exemplary illustration of a sequencer,

FIG. 12b is a block diagram of an object tree as a map of the sequencer shown in FIG. 12a,

FIG. 13 is a block diagram providing an example of the practical use of the type/instance concept when configuring an automation system, and

FIG. 14a, b each is a block diagram providing an example of the practical use of the type/instance concept with OTR interface technology.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

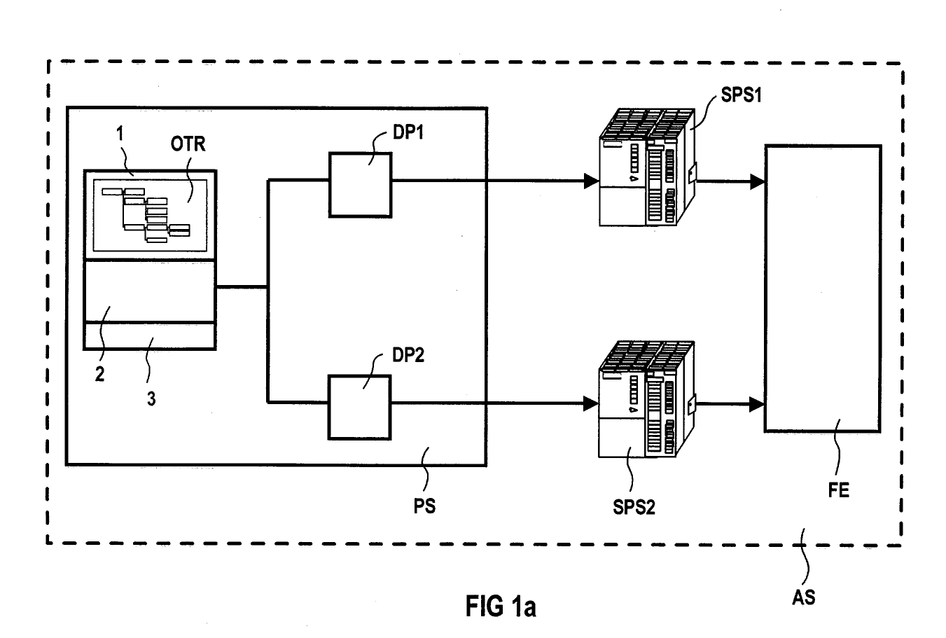

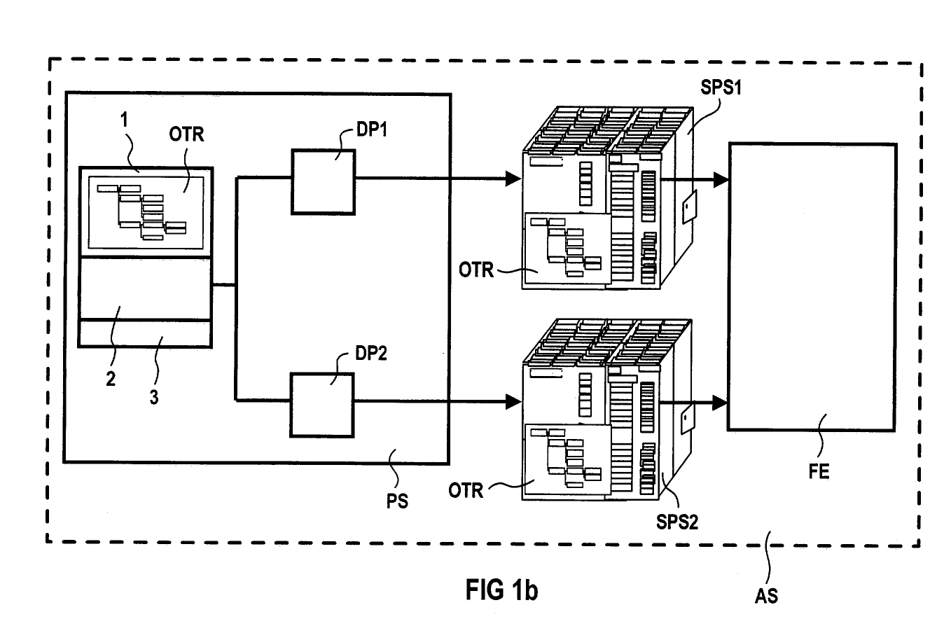

FIG. 1 shows a basic illustration of a block diagram for configuring and programming an automation system AS. The automation system AS includes a configuration system PS, a first programmable logic controller SPS1, a second programmable logic controller SPS2 and a fabrication device FE. The configuration system PS is used to produce a first data program DP1, which is capable of execution on the first programmable logic controller SPS1, and to produce a second data program DP2, which is capable of execution on the second programmable logic controller SPS2. The first and second data programs DP1, DP2 are programmed using a computer 1, 2, 3 which is formed from a computer unit 2, an associated keyboard 3 and a screen 1. The screen 1 of the computer 1, 2, 3 shows, by way of example, an object tree OTR which identifies the fundamental architecture structure of the software components of the data programs DP1, DP2. The particular feature of the exemplary embodiment shown in FIG. 1 is that both the first data program DP1 and the second data program DP2 are respectively based on software components which have a data structure formed of an object tree OTR with hierarchically graduatable objects.

The software structure based on an object tree with hierarchically graduatable objects gives rise to efficient editing mechanisms which allow all the structures to be mapped in a standard data model. Overall, a standard configuration for all plant areas of the fabrication device FE is obtained at the same time as fully consistent data storage. All the plant components of the fabrication device and associated views are stored in a single data model within the object tree structure. Multiple input of data for different special systems is thus not necessary.

FIG. 1b shows a block diagram of the basic design of an automation system with an OTR core as a configuration system and an OTR core as a runtime system in a programmable logic controller (PLC). With regard to the functional relationships and the references used, reference is made to FIG. 1.

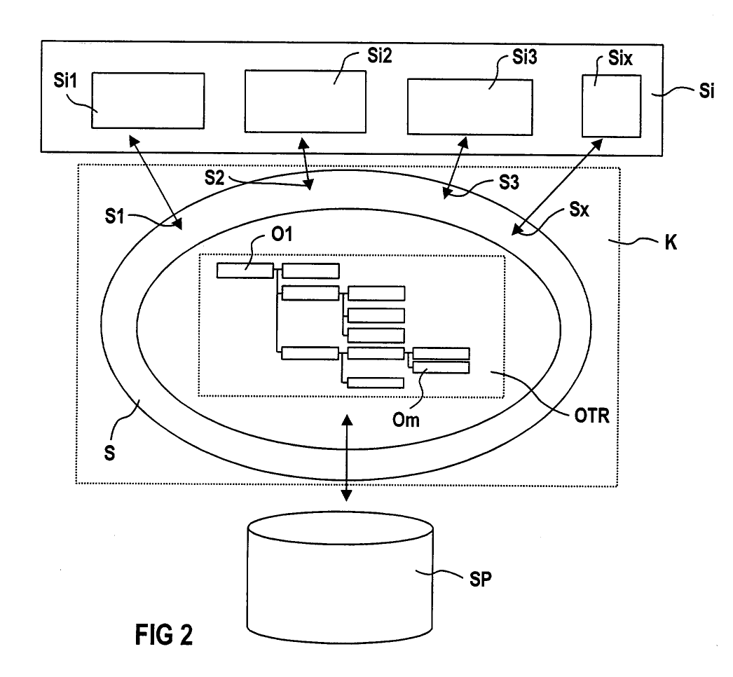

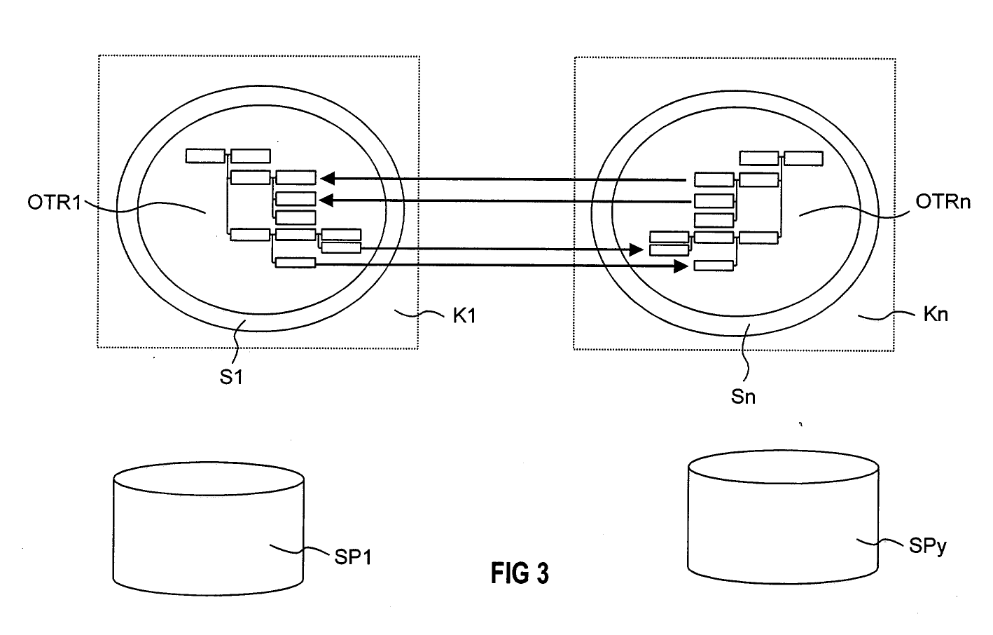

FIG. 2 shows a schematic illustration of the basic design of an object tree OTR, of a software component K and of its interaction with different views SI1 . . . SIx. The basis of the object tree structure for the software component K is formed by the object tree OTR, which is made up of hierarchically graduatable objects O1 . . . Om. In addition, the software component K has an interface S which specifically includes individual interfaces S1 . . . Sy. The software component K is stored on a storage medium SP.

The particular feature of the data structure shown in FIG. 2 is, inter alia, that all the views SI . . . SIx of the software component K are actually connected to data in the object tree OTR for the software component K. This results in single data storage for all views, which means that data inconsistencies are not only avoided but rather become impossible.

In the exemplary embodiment shown in FIG. 2, the first view SI1 is used, by way of example, to show the software component in a 3D view, the second view SI2 is used to show the software component K in a flowchart view or a sequential function chart (SFC) view, and the third view SI3 is used, by way of example, to give a table view of the software component. The data structure shown in FIG. 2 is the basis for an efficient editing mechanism which allows all structures, particularly in an automation plant, to be mapped in a standard data model. Since all the components form the basis of one and the same structural mechanism, software components and their objects can be logically combined with other objects and software components by this standard mechanism.

FIG. 3 shows a schematic illustration of the basic interplay between a plurality of software components K1 . . . Kn as a connection between various object trees. In this case, the software components K1 . . . Kn have the same structural design as the software component already explained in connection with FIG. 2. In the exemplary embodiment shown in FIG. 3, the data for the first software component K1 are stored in a first data memory SP1 and the data for the software component Kn are stored in a data memory SPy. Dashed arrows indicate that the software components K1 . . . Kn can also be stored in other data memories in each case, however.

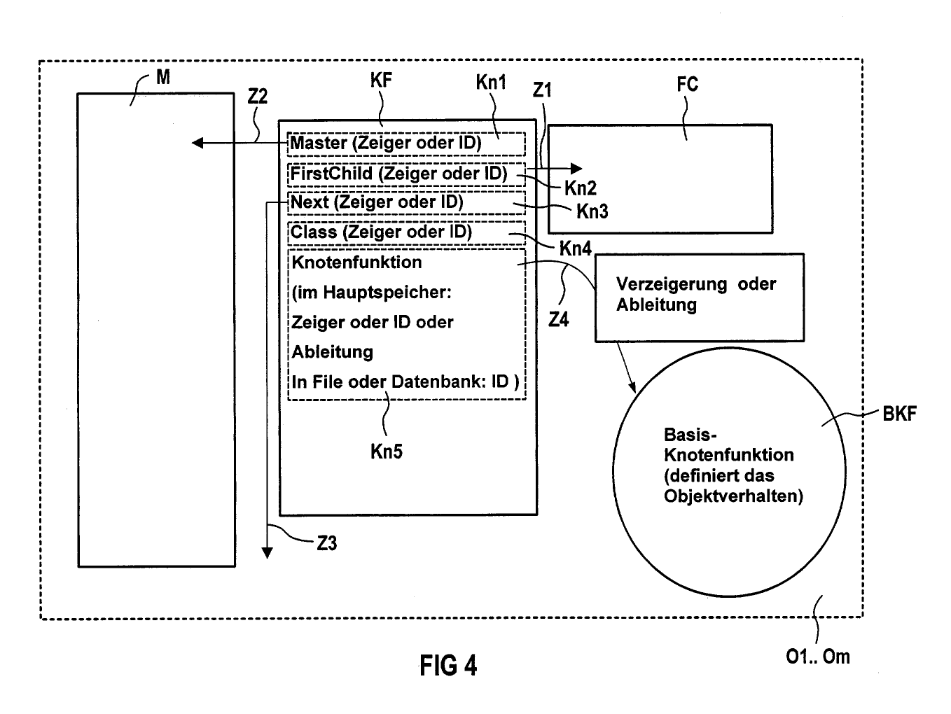

FIG. 4 shows a basic illustration of the general data structure of an object O1 . . . Om as used within an object tree (cf. FIG. 2). The object O1 . . . Om shown in FIG. 4 includes a data block KF which describes the node function of the object O1 . . . Om. In this case, the elementary node function of the object O1 . . . Om includes a hierarchic breakdown using pointers Z1 . . . Z4 and a definition of the base node function BKF. In this context, the base node function BKF defines the object behavior of the object O1 . . . Om. By way of example, the functionality can be an AND function which has the function of logically combining the subordinate object nodes using a logic AND function. The base nodes can be organized in a hierarchy and can thus be used to generate more complex objects. The pointer Z2 points to a “master” M, while the pointer Z1 points to the first child FC. Similarly, the data block KF, which defines the node function of the object O1 . . . Om, contains further node functions KN1 . . . KN5, with the pointer Z4 being used to break down the base node function BKF.

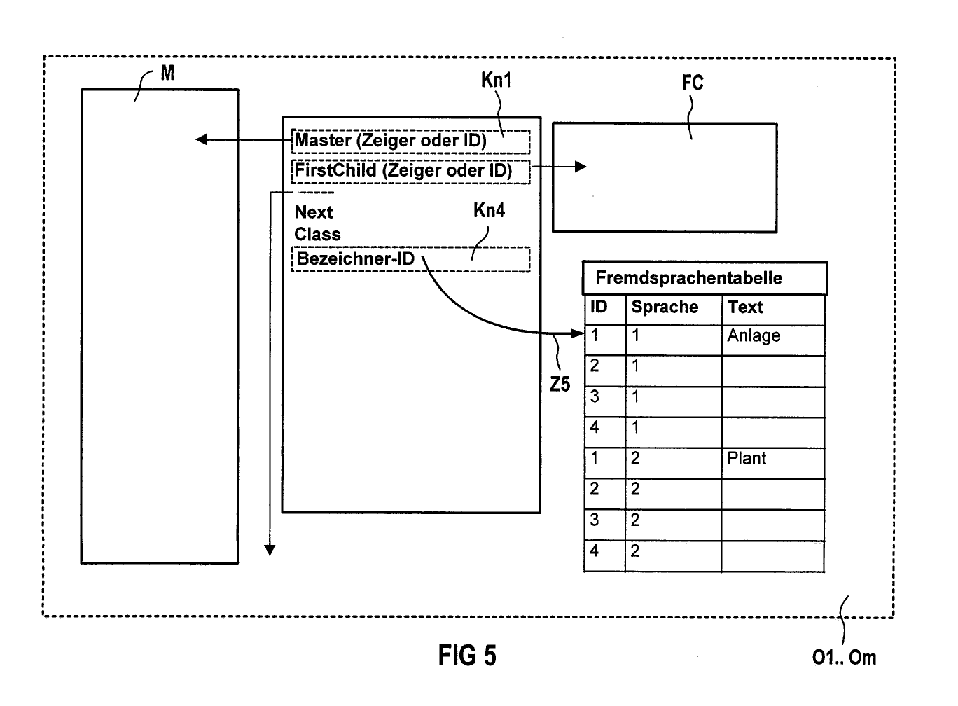

FIG. 5 shows a basic illustration of the data structure of an object for producing multilingual software components. In this case, the structural design of the object corresponds to the basic design already shown in connection with FIG. 4. In addition to the node functions shown in FIG. 4, the object shown in FIG. 5 contains a further node function KN5 which points to a foreign language table using a pointer Z5. In the foreign language table, respective identifications are used to link different languages and text outputs for the views associated with the respective object. The standard data storage concept which thus exists therefore easily allows a standard method for translating all the plant components into different foreign languages without the need for changes to the structural basic design of the software components.

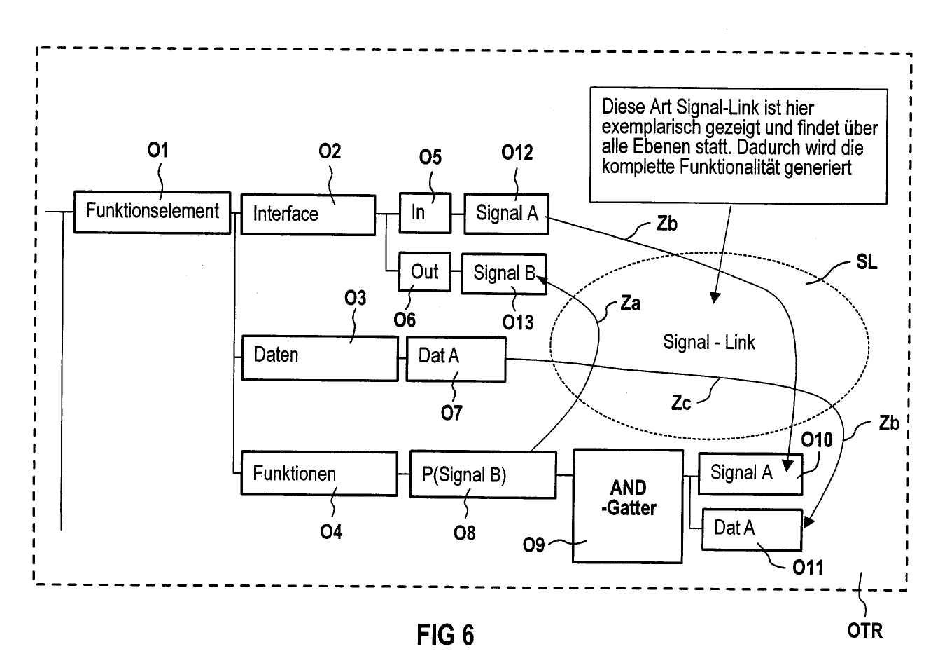

FIG. 6 shows a schematic illustration of an object tree OTR. The object tree OTR includes objects O1 . . . O13. The functionality of the object tree OTR shown by way of example in FIG. 6 is produced by a link mechanism SL for logically combining individual objects or signals defined by objects. The object O1 is a functional element, the object O2 is an interface, the object O3 defines data, and the object O4 defines functions. The objects O5, O6 form an input and an output, while the objects O12 and O13 identify the respectively associated input signal A and output signal B. The object O7 identifies the signal DatA, and the object O8 identifies a signal P which, as signal B, is linked by a pointer ZA to the object O13, i.e. to the signal B. The object O9 forms an AND gate, while the objects O10 and O11 identify the signal A, which is supplied as a link by a pointer ZB. A pointer ZC is used to link the object O7 to the object O11.

FIG. 6 shows a signal flow resulting from the link mechanism SL for the purpose of logically combining the signals “signal A” for the object O12 and for the object O7 (“DatA”) using an AND gate O9. The result of this logic combination is in turn supplied to the signal B for the object O8 by a link ZA. The link mechanism shown by way of example in FIG. 6 can also be used for logically combining complex objects with one another, such as the dynamic opening of a machine in the view of a plant.

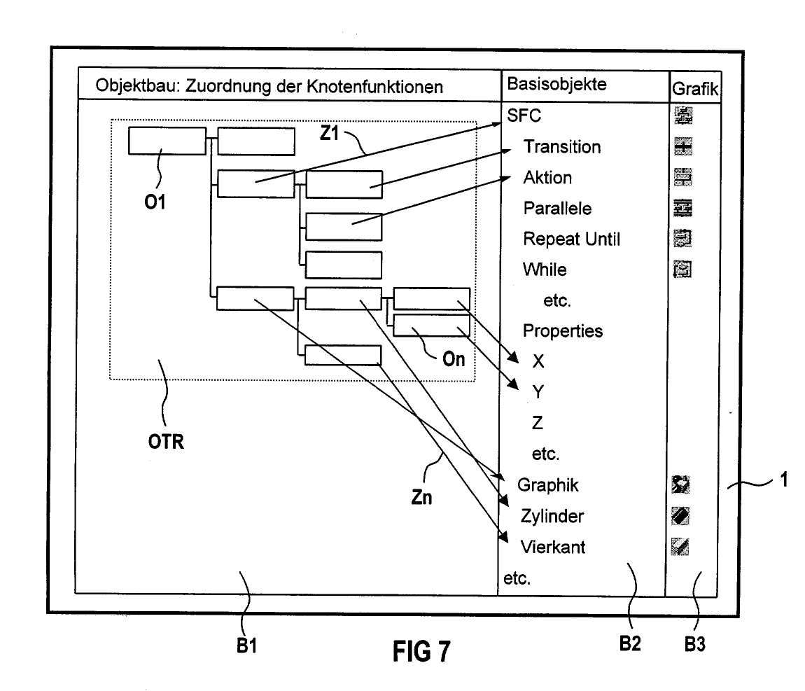

FIG. 7 shows a schematic illustration of a screen window 1 for defining the functionalities of an object tree OTR with hierarchically graduatable objects. In this case, the screen window is divided into three basic screen subareas B1, B2, B3. The first screen subarea BI shows the object tree OTR to be configured with the individual objects, while the second screen area B2 lists the node functions of base objects in tabular form. A graphic associated with these base objects is shown graphically in the third area B3—if provided. The respective base objects are associated with the individual objects by a breakdown of the individual objects in the object tree OTR in the first screen subarea with the respective base objects in the second screen area B2.

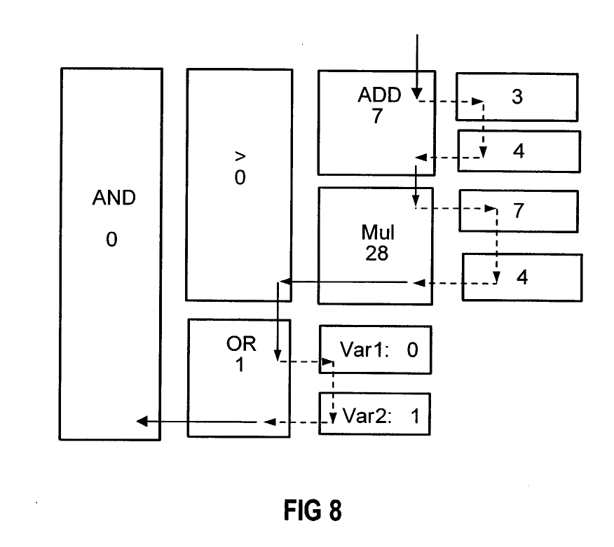

FIG. 8 shows an exemplary illustration of the production of function diagrams using an object tree. As an example, FIG. 8 shows a logic gate which is made up of respective base nodes.

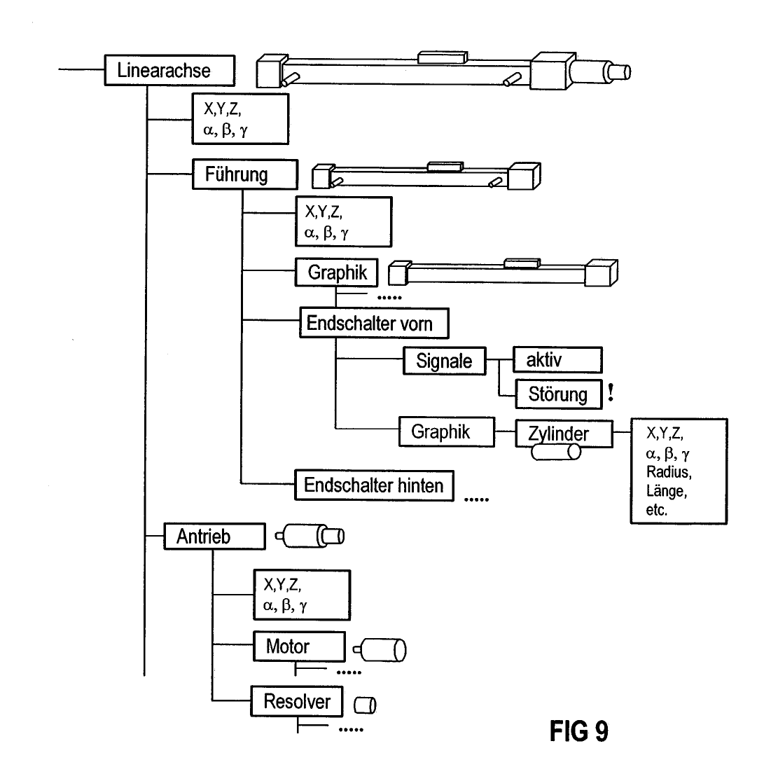

FIG. 9 shows an exemplary illustration of the production of 3D graphics using an object tree. The respective 3D graphics for a linear axle include corresponding subobjects, such as guidance and drive. Thus, the 3D graphic for the drive shown in FIG. 9 is made up, by way of example, of a “resolver” and a motor. In this case, the full tree structure for the 3D graphic is stored in the object tree base structure.

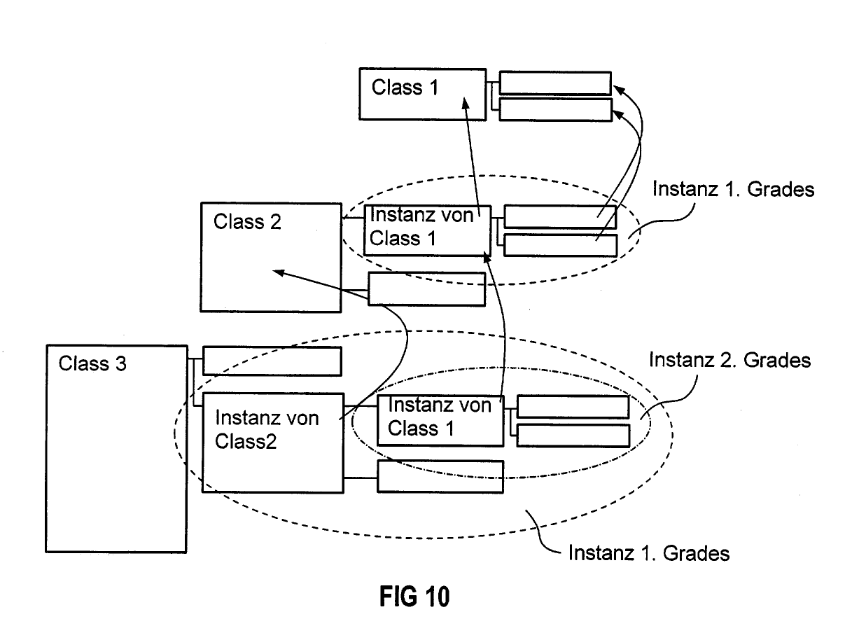

FIG. 10 shows an object tree with broken down objects using the type/instance concept. The type/instance concept makes it possible to generate new more complex objects from previously generated less complex objects. This gives a hierarchic instantiation system which is superimposed on the automation plant's design hierarchy. If a property for a class is altered, added, moved or erased, then all instances are immediately concomitantly changed, either automatically or under user control, which means that the consistency of the data structure is maintained. The particular feature of the type/instance concept shown in FIG. 10 is that classes, already contrary to popular object-oriented concepts, also have full functionality. This ability to have full functionality is based on the fact that even classes already have data with reserved memory and executable program modules. The advantage of such a procedure is that classes can be treated like prototypes, which can be fully tested immediately without additional instantiation, i.e. without additional involvement. The full functionality of the classes in turn contains all the views and facets of automation technology.

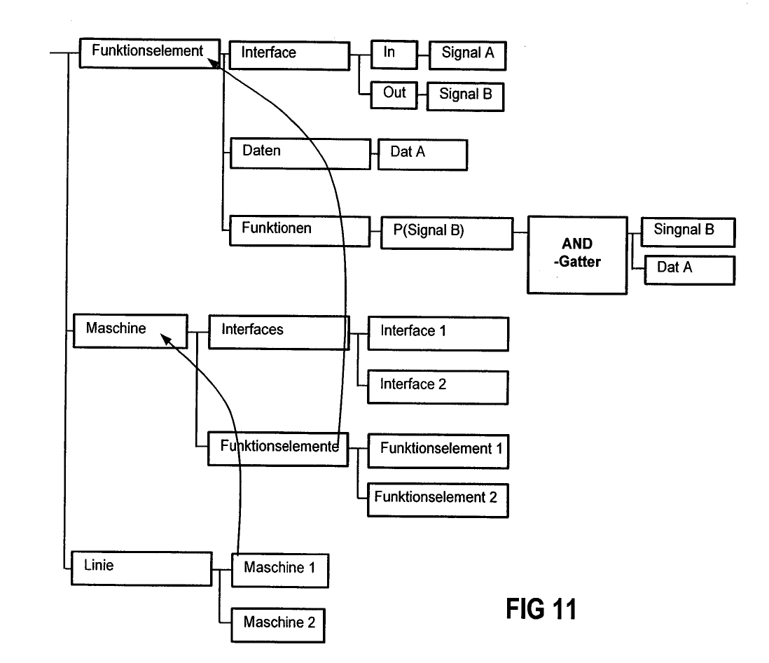

FIG. 11 shows such a basic illustration of a design for plant modules using a type/instance concept.

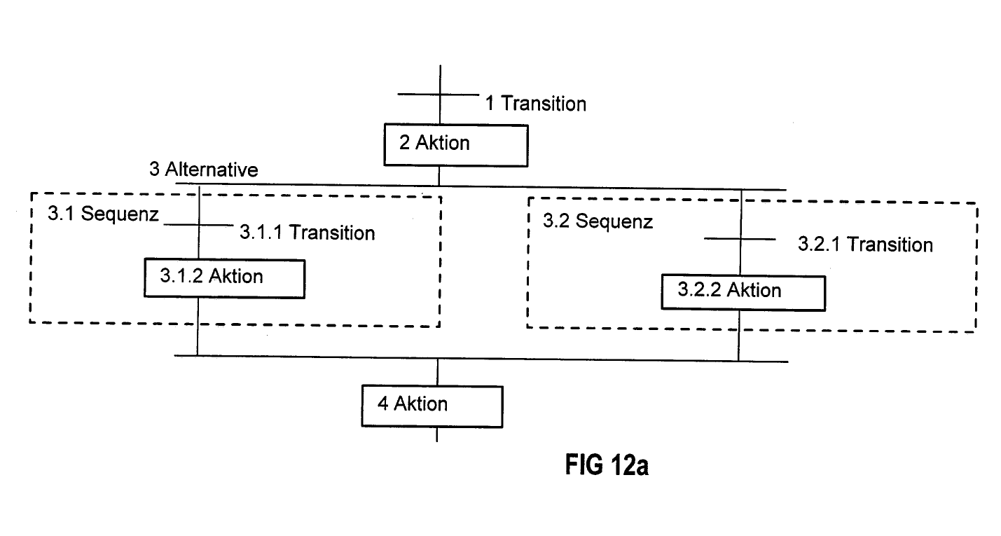

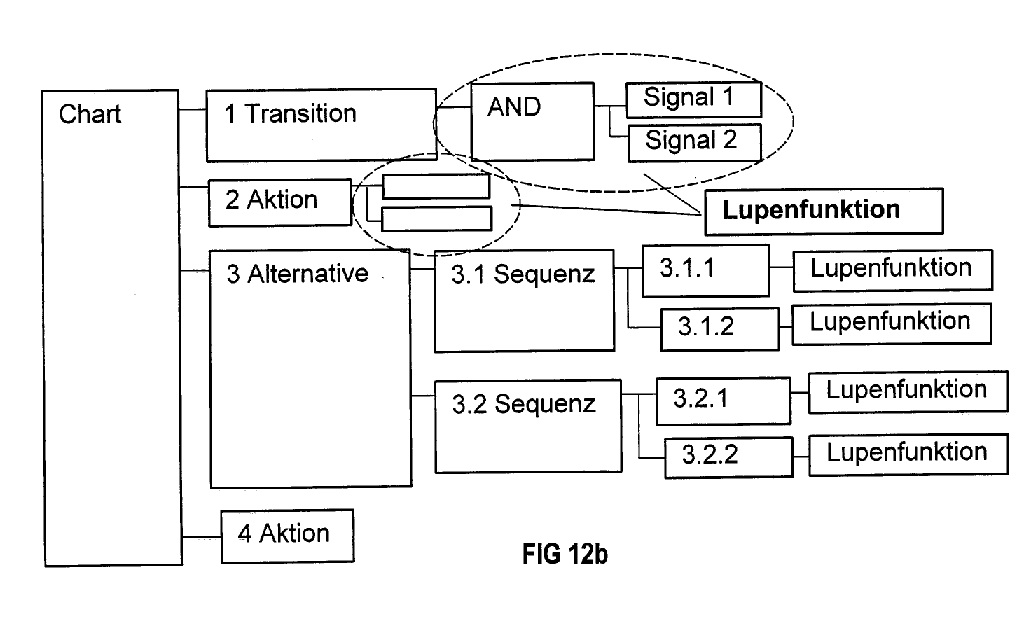

FIG. 12a shows an exemplary illustration of a sequencer, as used, by way of example, in popular configuration systems for automation technology. Such a sequencer includes actions and transitions, i.e. states and state transitions. By contrast, FIG. 12b shows an object tree as a map of the sequencer shown in FIG. 12a.

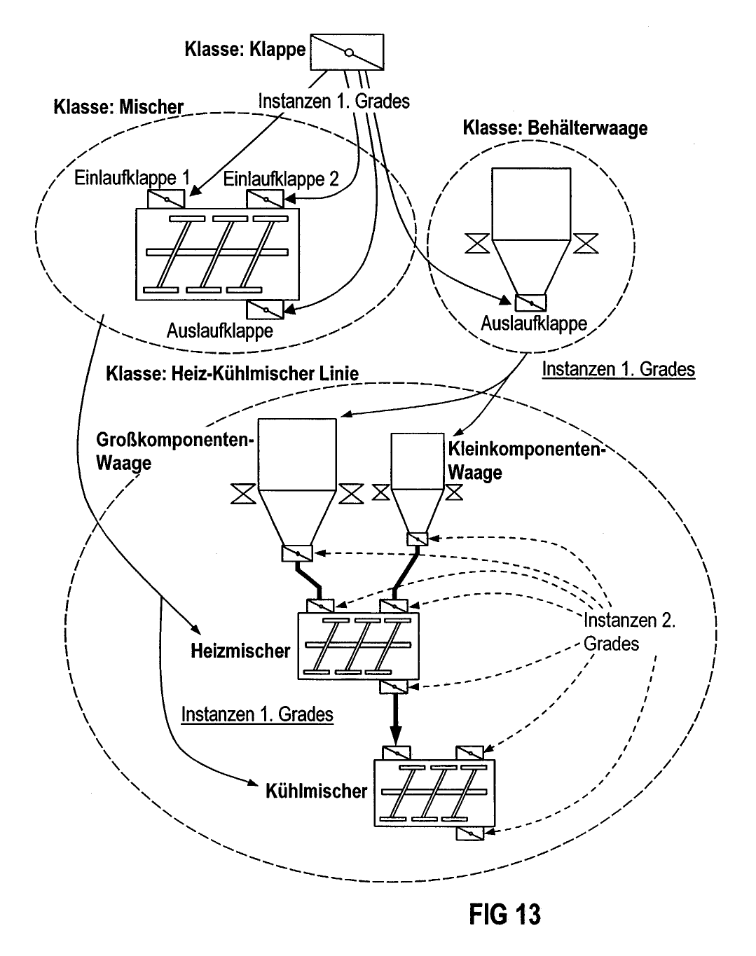

FIG. 13 shows an example of the practical use of the type/instance concept when configuring an automation system.

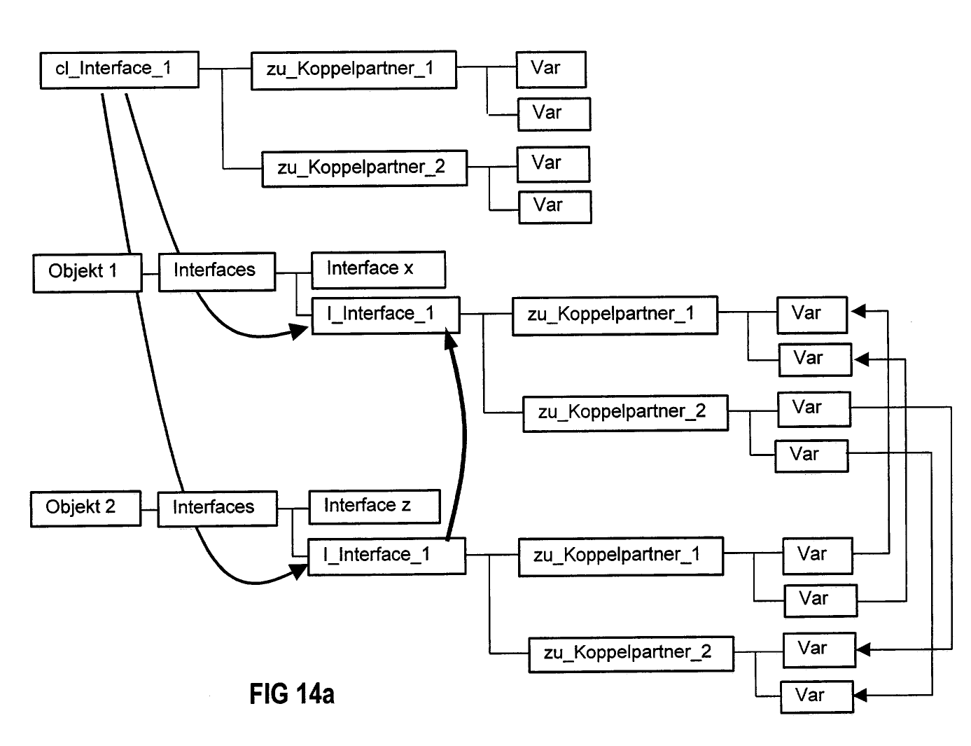

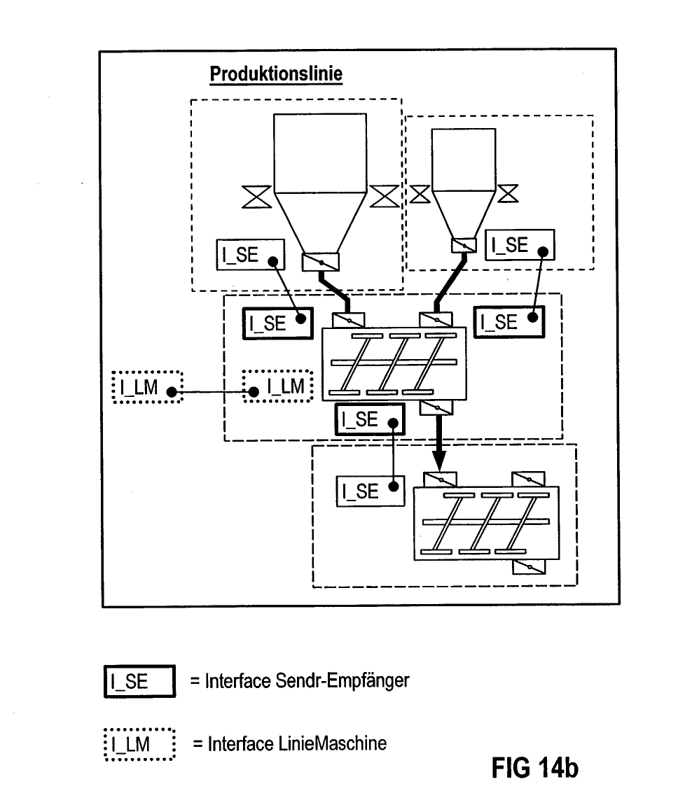

FIGS. 14a, b show an example of the practical use of the type/instance concept with OTR interface technology.

In summary, the invention thus relates to a system and a method for configuring an automation system. For standard configuration with simultaneously consistent data storage, a configuration system with a standard data model is proposed which is based on an object tree with hierarchically graduatable objects.

The invention has been described in detail with particular reference to preferred embodiments thereof and examples, but it will be understood that variations and modifications can be effected within the spirit and scope of the invention.

What is claimed is:

1. A system for configuring software components, particularly software components in an automation system, comprising:
at least one software component having a data structure formed as an object tree with hierarchically graduatable objects.

2. The system as claimed in claim 1, wherein the object tree maps views of a software component.

3. The system as claimed in claim 2, wherein said at least one software component includes a first software component type as a class.

4. The system as claimed in claim 3, wherein the first software component type contains at least one of data and executable functions.

5. The system as claimed in claim 4, wherein said at least one software component includes a second software component type as an instance.

6. The system as claimed in claim 5, further comprising means for automatically changing an instance produced from a class if a corresponding class is changed.

7. The system as claimed in claim 6, wherein the first and the second software component types are of a same design.

8. The system as claimed in claim 7, further comprising means for generating at least one of more complex objects and software components from previously generated objects.

9. The system as claimed in claim 8, further comprising means for producing a change list, the change list being provided for logging changes in a software component.

10. The system as claimed in claim 9, further comprising means for using the change list produced for a first software component to implement changes stored in the change list on a second software component.

11. The system as claimed in claim 10, wherein an object of a software component has at least one object node.

12. The system as claimed in claim 11, wherein an individual object node is an object.

13. The system as claimed in claim 12, wherein the at least one object node includes at least one of pointers to and identification numbers for other nodes.

14. The system as claimed in claim 13, wherein the at least one object node has an identification number for defining at least one foreign language for an object.

15. The system as claimed in claim 14, further comprising means for organizing base nodes in a hierarchy and for generating more complex objects from the base nodes.

16. The system as claimed in claim 15, wherein at least one object has an elementary node function with a hierarchic breakdown.

17. The system as claimed in claim 16, wherein the at least one object is provided with a base node function for determining functionality of at least one of a node and subordinate nodes.

18. The system as claimed in claim 17, further comprising a link mechanism to logically combine at least one of signals and objects to generate a functionality for at least one of an object and a software component.

19. The system as claimed in claim 18, further comprising object tree means for using the object tree to produce at least one of a function diagram, a flowchart and a sequencer for an automation component.

20. The system as claimed in claim 19, wherein said object tree means uses the object tree to set up at least one of a 2D graphic and a 3D graphic.

21. The system as claimed in claim 20, further comprising means for using a type/instance concept to respond to changes to a class by concomitantly changing all instances one of directly and by control.

22. A method, comprising:
configuring an automation system based on at least one software component having a data structure formed as an object tree with hierarchically graduatable objects.

23. At least one computer readable medium storing a computer program for controlling a processor to perform a method, comprising:
configuring an automation system based on at least one software component having a data structure formed as an object tree with hierarchically graduatable objects.
